(19) United States
(12) Patent Application Publication
(10) Pub. No.: US 2013/0340492 A1
(43) Pub. Date: Dec. 26, 2013

(54) Locking Device And Leaves Outfitted Therewith And Leaf Installation

(71) Applicants: Oliver GENDIG, Gevelsberg (DE); Thomas UEBELGÜNNE, Ennepatal (DE); Franz Josef HÖVENER, Lunen (DE); Jan MEULENBELD, Breckerfeld (DE)

(72) Inventors: Oliver GENDIG, Gevelsberg (DE); Thomas UEBELGÜNNE, Ennepatal (DE); Franz Josef HÖVENER, Lunen (DE); Jan MEULENBELD, Breckerfeld (DE)

(73) Assignee: DORMA GmbH + CO. KG

(21) Appl. No.: 13/925,463

(22) Filed: Jun. 24, 2013

(30) Foreign Application Priority Data
Jun. 25, 2012 (DE) 10 2012 012 415.5

(51) Int. Cl. E05B 1/00; E05B 19/00

(52) U.S. Cl. CPC E05B 1/0038; E05B 19/00
USPC 70/344; 292/57

(57) ABSTRACT

A locking device having a housing installed in a stationary manner in or at a leaf. The locking device has a locking element that is movable translationally into and out of the housing and has at least a first actuating device including a handle piece accessible from outside the housing that is operatively connected to the locking element such that the locking element is moved when this handle piece is moved along a predetermined movement path. The locking device has a second actuating device received in the housing that includes a transmission device which can be rotationally actuated and turned or rotated by a turning part. The turning part is accessible from outside the housing and is operatively connected to the locking element so that the locking element is moved out of the housing by turning the turning part in a locking direction.

### BACKGROUND OF THE INVENTION

1. Field of the Invention

The invention is directed to a locking device for leaves and leaves outfitted therewith and a leaf installation outfitted with a leaf of this kind.

2. Description of the Related Art

Locking devices are known per se. One is a conventional door lock having a latch that prevents the respective leaves of a leaf installation from being swiveled in an opening direction. To move the latch, a key-operated profile cylinder and a turning knob or door handle may be provided, the latch being moved by actuation thereof between a locking position and an unlocked or release position in which the leaf is no longer prevented from moving.

Another locking device is a locking bolt that engages in the locking position in a corresponding recess formed in turn in an element that is stationary with respect to the leaf installation such as a floor. This also prevents the respective leaf from moving. To move the locking bolt between the locking position and the release position, a displaceable handle piece can be provided. By moving this handle piece, the locking bolt is moved in a corresponding manner.

The respective leaf and the lock thereof must generally be secured on one side of the leaf to prevent unwanted releasing of the lock, for example, in entrance doors in which the side to be secured is generally the outer side of the leaf in relation to a building or room. Securing of this kind is not required on the inner side. For such cases, so-called panic fittings have been developed that allow the leaf to be unlocked and opened, but such fittings are complicated with respect to construction and are expensive.

In case of sliding doors, there are floor locks in which a locking bolt engages in a floor recess, thereby preventing movement of the leaves so that the respective latch is locked. Profile cylinders are used for unlocking. While these profile cylinders offer security, they are difficult to access in the floor area. This is advantageous for the outer side of the leaf but not for the inner side of the leaf.

### SUMMARY OF THE INVENTION

An object of one embodiment of the invention is to overcome the disadvantages of the prior art.

One embodiment of the invention is a locking device having a housing. The housing is designed to be installed in a stationary manner in a leaf or is arranged at the leaf in a stationary manner, i.e., the housing is securely held at or in the respective leaf. Further, the locking device has a locking element that is movable translationally into and out of the housing. When moved out, the locking element is in the locking position and projects out of the housing. Additionally, the locking device has at least a first actuating device comprising a handle piece, which is accessible from the outside with respect to the housing. This handle piece is operatively connected to the locking element such that the locking element is moved into and out of the housing when this handle piece is moved along a predetermined movement path. In other words, by moving the handle piece a person can move the locking element in direction of the locking position or away from the locking position and, therefore, into the unlocked or release position. Further, the locking device has a second actuating device received in the above-mentioned housing. This actuating device comprises a transmission device that can be rotationally actuated. This transmission device can be turned or rotated by a turning part. Like the handle piece, the turning part itself is accessible from outside the housing. Further, the turning part is so designed and operatively connected to the locking element that the locking element is moved out of the housing by the above-mentioned turning or rotation of the turning part in a locking direction. This means that the turning part has the same effect on the locking element as the handle piece. On the one hand, this solution has the advantage that the handle piece can be operated from the inner side of the respective leaf, i.e., no key or the like is required. On the other hand, it has the advantage that the turning part can be constructed, for example, as a profile cylinder, i.e., as a half-cylinder, which is accessible from one side, its keyway being accessible from the outer side of the leaf. This makes it possible to lock and unlock or release a leaf by different actuating devices but with one and the same locking element. This simplifies the construction of the leaf and usability is improved or remains intact. Further, costs are minimized.

Further, the locking device is preferably designed such that the turning part or handle piece is moved with a movement of the handle piece or turning part, respectively. In other words, the movement of one part is correspondingly transmitted to the other respective part. Accordingly, for example, when the handle piece is moved in a direction corresponding to the movement of the locking element in direction of the locking position, the turning part is turned in a direction that would also be taken by the turning part if a person wanted to move the locking element into the locking position by the turning part. This simplifies the construction of the locking device because the handle piece and turning part need not be uncoupled from one another with respect to their movements.

In addition or alternatively, the locking device according to one embodiment of the invention can be designed to lock the locking element at least in the locking position. This enhances security in that locking cannot easily be unlocked.

The housing is advantageously designed, according to the respective position of the locking element to be locked, to prevent the handle piece or turning part from moving away from its locked position at least to a predetermined extent. This allows locking to be effected by this same handle piece or turning part; additional elements are not required. Further, in case the movements of the handle piece and turning part are coupled as discussed above, both parts are accordingly locked at the same time. Therefore, the user perceives from the locking of the handle piece or turning part that the locking element is locked.

Further, each of the locking devices mentioned above can have elements configured to urge the locking element in or away from the direction of the locking position; that is, the user is assisted in the respective movement of the locking element, which enhances ease of use.

Further, the first actuating device and/or the second actuating device can be designed and operatively connected to the locking element such that the locking element is moved into the housing when moving the handle piece or turning the turning part in a direction corresponding to a movement direction of the locking element away from the locking position. In other words, the locking element can also be moved into the housing again and, therefore, away from the locking position by the handle piece or turning part; additional elements are not required. This keeps the construction very simple.

The turning part can preferably have at the outer circumference thereof a lock bit, which is rotated along with a rotation of the turning part, that drives the locking element in a predetermined portion of the turning movement so that the locking element is moved translationally. This arrangement substantially corresponds to a conventional lock cylinder arrangement. In other words, known, inexpensively produced parts can be used.

The turning part preferably has a profile cylinder accessible from one or both sides. This type of turning part is inserted into the housing in a stationary manner and is designed to be turned at least in locking direction by a key. This solution also serves to keep costs low.

The transmission device can comprise a turning knob or door handle. The latter is arranged so as to be fixed with respect to rotation relative to the turning part or so that it can be coupled with the turning part so as to be fixed with respect to rotation relative to it, at least in locking direction. In other words, the invention also makes possible a completely keyless solution. Coupling is an option, for example, when using safety lock cylinders.

A leaf according to the invention has at least one of the locking devices mentioned above. Further, it is designed to receive or hold the locking device in a stationary manner such that the locking element protrudes from the leaf when the locking element projects out of the housing. By this design, the leaf is adapted to be locked.

Accordingly, a leaf installation according to one embodiment of the invention has at least one leaf of this kind. Further, this leaf is arranged so as to be movable with respect to the leaf installation. Further, the leaf installation has a locking receptacle. The locking receptacle and locking element are arranged in such a way that the locking element engages in the locking receptacle in the locking position such that the leaf is prevented from moving in at least one movement direction. In case of a floor lock, for example, the locking receptacle forms a floor receptacle and the locking element is a locking bolt, i.e., conventional, inexpensively produced parts can also be used in this case.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention are given in the following description of a preferred embodiment form of the invention.

FIG. 1 is a locking device in a perspective view;

FIGS. 2a-2c are views of the locking device of FIG. 1 without a housing cover;

FIG. 3 is a portion of the locking mechanism of the locking device of FIG. 1;

FIGS. 4a-4b are exploded, detailed views of the locking device referring to FIG. 3;

FIGS. 5a-5b are a leaf provided with the locking device of FIG. 1; and

FIG. 6 is a leaf installation provided with the leaf of FIG. 5.

### DETAILED DESCRIPTION OF THE PRESENTLY PREFERRED EMBODIMENTS

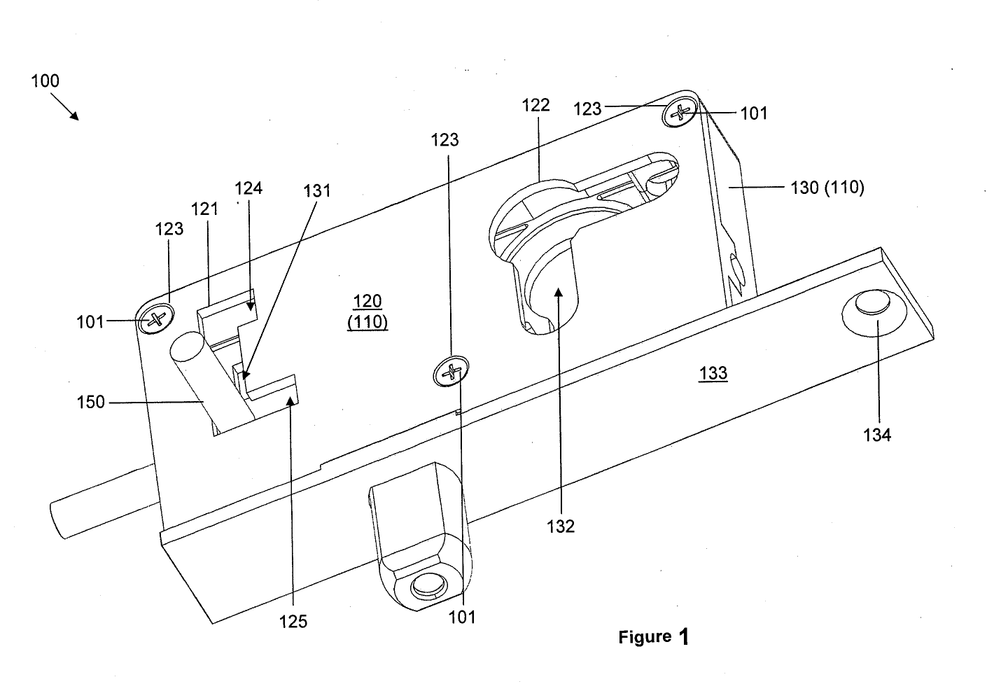

FIG. 1 shows a portion of a locking device 100 according to one embodiment of the invention. The locking device 100 has a housing 110, which substantially comprises two housing parts or housing halves 120, 130. Housing part 120, which is formed in this instance as a housing cover, has fastening holes 123 through which, in this instance, countersunk head screws 101 are screwed to the other housing part 130. Adjoining the side of the housing part 130, for example, which in this case is the front side, is a face plate 133. In this case, for example, a fastening hole 134 is provided in the face plate 133 so that the housing 110 and locking device 100 can be inserted in a known manner into a (door) leaf so as to be stationary. Therefore, the housing 110 is formed from the outside as a conventional door lock case.

In the illustrated example, an aperture 121 and 131, respectively, is formed in each housing part 120, 130. The apertures 121, 131 receive a handle piece 150, described more fully later, of the locking device 100 and are shaped in conformity with the actuating path or movement path, likewise described more fully below, of the handle piece 150.

Further, there is another aperture 122 and 132, respectively, in each housing part 120, 130, for example. These apertures 122, 132 serve to receive a lock cylinder used by way of example but is not shown in more detail. The role of the lock cylinder will also be described in more detail later.

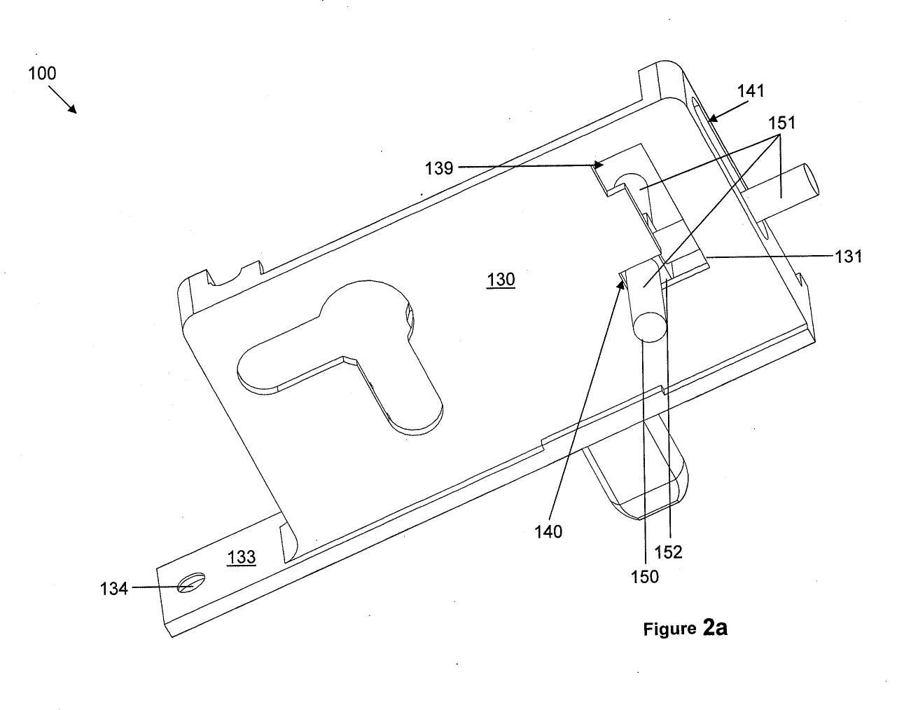

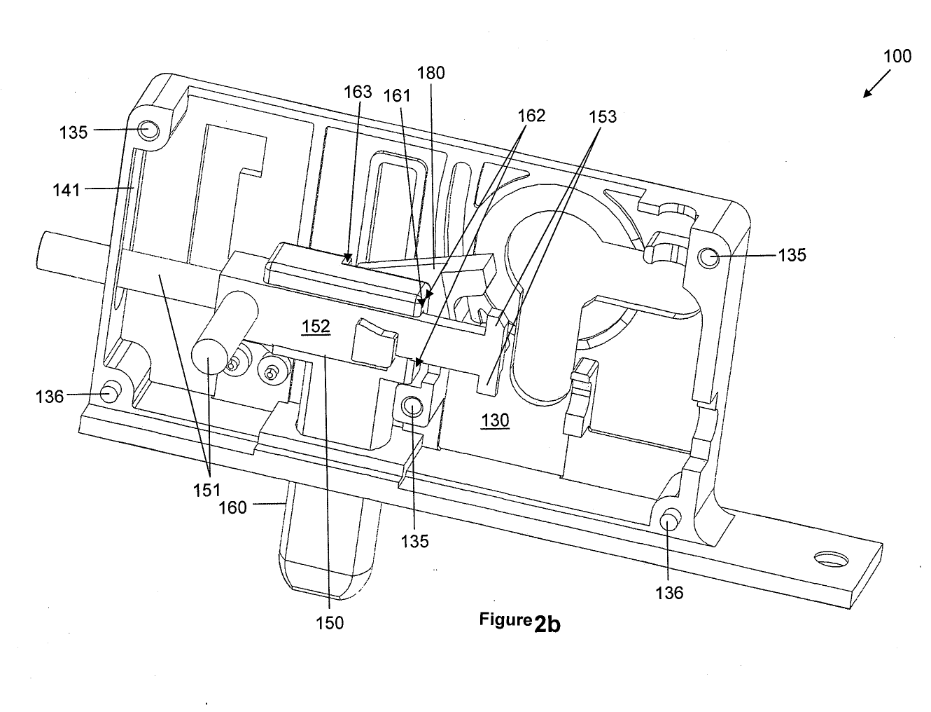

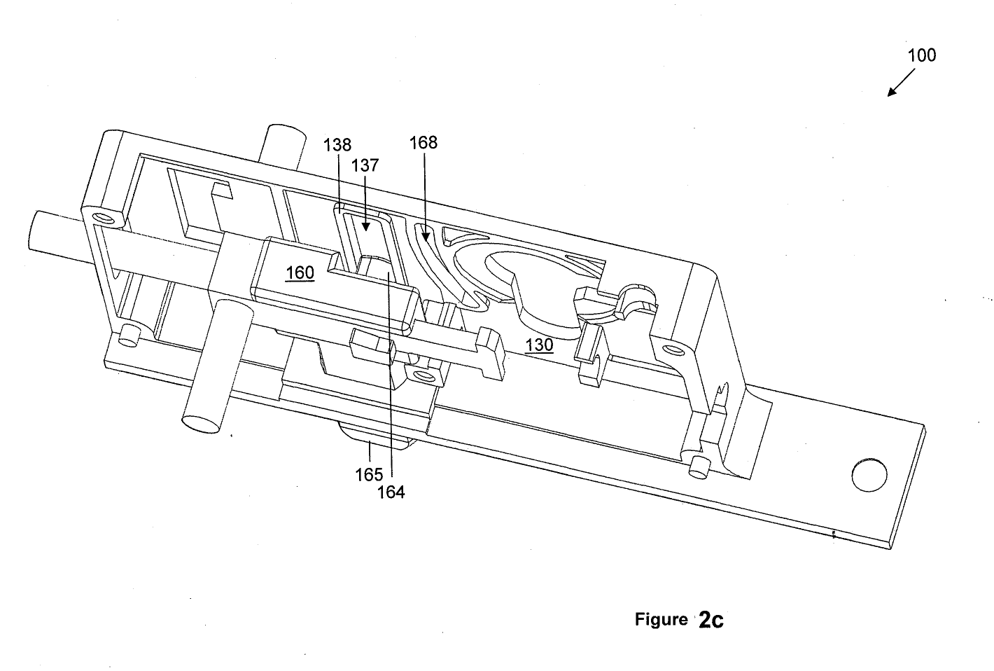

FIG. 2a shows the locking device 100 of FIG. 1 from the perspective of housing part 130, while housing part 120 is not shown in this view. The face plate 133 with its fastening hole 134 is also shown.

As can be seen, the handle piece 150 has three portions 151 that project from a guide portion 152 of the handle piece 150. The guide portion 152 will be described more fully later. The handle piece portion 151 on the right-hand side in this case passes through a second aperture 141 formed at the front of housing part 130.

The apertures 122 and 132 each have two locking receptacles 124, 125 (FIG. 1) and 139, 140, (FIG. 2a) respectively. The lock receptacles serve to prevent the handle piece portion 141 passing through them from moving in direction of the other respective locking recess 125, 124 and 140, 139, respectively, i.e., the handle piece 140 is locked in position with respect to the latter.

FIG. 2b shows the locking device 100 of FIG. 2a from the opposite side; that is, a portion of the “inner workings” of the locking device 100 is shown.

Housing part 130 has threaded bore holes 135 for the screws 101, not shown here, and two positioning projections 136 protruding in direction of housing part 120, not shown. These positioning projections 136 engage in corresponding insertion openings of housing part 120, not described in more detail, so that both housing parts 120, 130 are held in position relative to one another for screwing together.

The above-mentioned guide portion 152 of the handle piece 150 is shown particularly clearly. The guide portion 152 is received in a guide groove 161 of a locking bolt 160 so as to be movably guided perpendicular to a movement direction of the locking bolt 160.

The guide portion 152 has projections 153 at its end remote of the handle piece portion 151, on the left-hand side in this instance, so that the handle piece 150 cannot be pulled too far toward the left-hand side out of the housing 110. These projections 153 are formed on or arranged at the guide portion 152 and extend away from the latter in opposite directions. Correspondingly, the locking bolt 160 has stop surfaces 162 at one side facing the projections 153. If the handle piece 150 is pulled out of the housing 110 in direction of the aperture 141, the projections 153 eventually come into contact with the stop surfaces 162 and the handle piece 150 cannot be moved any farther out of the housing 150.

A transmission part 180, which is described more fully below, is swivelably or rotatably arranged between the locking bolt 150 and the housing part 130.

The locking bolt 160 has an angular cutout 163 on its side facing the housing part 130. The transmission part 180 is partially arranged in the free space formed by the cutout 163.

FIG. 2c shows the locking device 100 of FIG. 2b from a different perspective and without the transmission part 180.

On its side facing housing part 130, the locking bolt 160 has a projection 164 protruding in direction of the housing part 130. This projection 164 is movably guided in a guide groove 137.

The guide groove 137 is formed at the inner side of the housing part 130 that faces the locking bolt 160 in that a wall portion 138 and is formed so as to protrude from this inner side, for example.

The wall portion 138 is formed such that the projection 164 and, therefore, the locking bolt 160 are guided in the direction of the inward and outward movement of a locking projection 165 of the locking bolt 160; that is, the wall portion 138 can be formed in a surrounding manner as is indicated here. However, it can also be formed only on either the right-hand side and left-hand side of the projection 164. Alternatively, the guide groove 137 can also be cut out of the housing part 130, for example.

The housing part 130 further has an arcuate guide groove 168 at the above-mentioned inner side. The role of this guide groove 168 will be described more fully in the following.

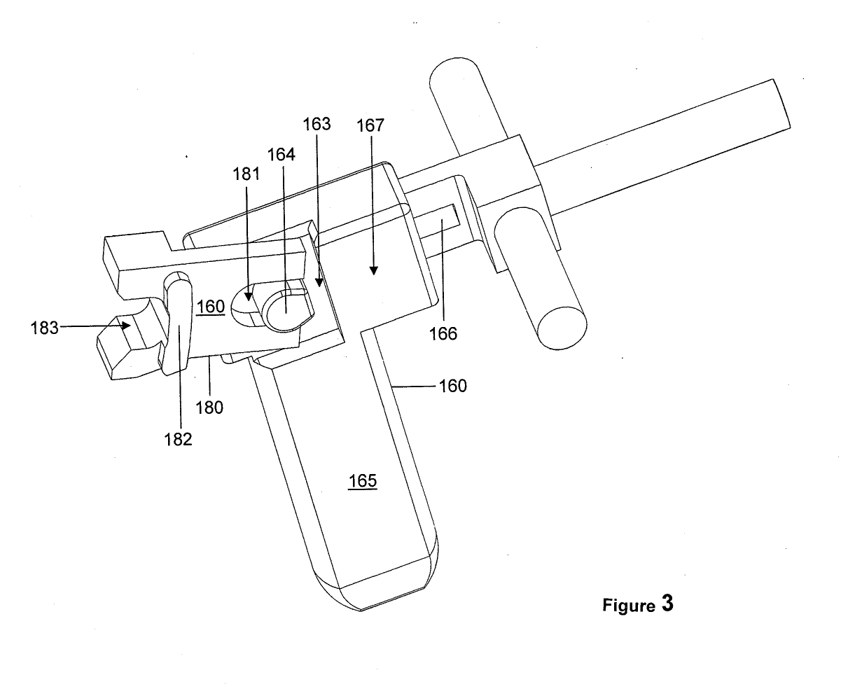

FIG. 3 shows the locking bolt 160 and the transmission part 180 in greater detail and from a perspective similar to that in FIG. 2a.

At its end facing the projection 164, the transmission part 180 has a recess 181, which gives the end a fork-like appearance. The projection 164 extends into this recess 181.

The projection 164 is shaped such that the transmission part 180 can swivel around the projection 164 without hindrance. Accordingly, the projection 164 has a twofold function. Aside from guiding the locking bolt 160 in the groove 137, not shown here, as was described above, it simultaneously forms the pivot for the transmission part 180.

Further, this view reveals the role of the recess 163. The recess 163 allows the locking bolt to contact the above-mentioned inner side of the housing part 130 with the surface 167 of the locking bolt facing the housing part 130 so that it can be moved in the housing 110 without play. This is useful for preventing rattling noises, for example.

The transmission part 180 is also formed in a fork-like manner at its end remote of the projection 164, i.e., it has a recess 183 in this location. The recess 183 allows engagement of a lock bit of a lock cylinder, not shown.

The lock cylinder is inserted in a known manner into the housing 110 so as to be stationary, particularly so that when the lock bit is rotated the lock bit engages in recess 183 and, when further rotated, drives the end of the transmission part 180 associated with the recess 183. Accordingly, the recess 183 is a driver recess. The transmission part 180 has a guide projection 182 on its side facing the above-mentioned groove 168 in order that this driving takes place in such a way that the projection 164 is moved along the guide groove 136 and, therefore, can be moved into or out of the housing 110 corresponding to the locking projection 165 depending on the rotating direction of the lock bit.

The guide projection 182 engages in the guide groove 168 and follows its arcuate shape; i.e., when recess 183 is driven upward referring to FIG. 3, the recess 183 remains at the same distance from the axis of rotation of the lock bit because of the arcuate shape. Therefore, jamming cannot occur. If the transmission part 180 is accordingly moved along the arcuate shape of the recess 168 around the axis of rotation of the lock bit, the recess 181 moves in a corresponding manner along an arcuate line with a greater radius around the same axis of rotation. Therefore, on the one hand, it likewise drives the projection 164 upward referring to FIG. 3, and the locking projection 165 is moved into the housing 11. But, on the other hand, the recess 181 also moves somewhat toward the projection 165. The recess 181 has an appropriate depth for preventing jamming. Also visible is a receptacle 166 which will be described later.

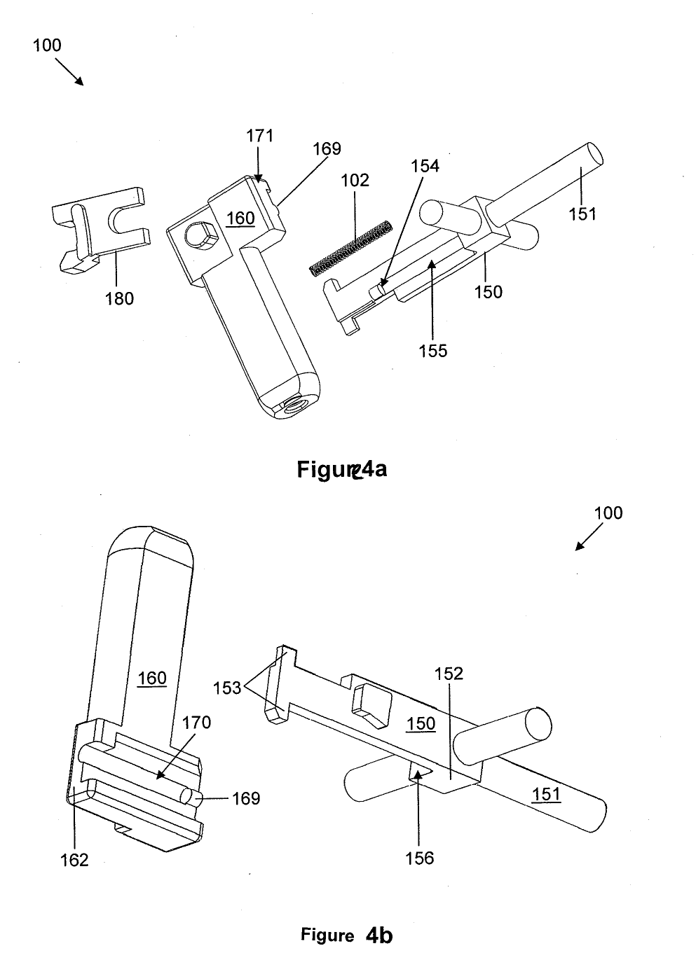

FIG. 4a is an exploded view of the arrangement of the transmission part 180, locking bolt 160 and handle piece 150 of the locking device 100.

As can be seen, the handle piece 150 has a groove-like recess 155, which is semicircular in cross section, for example, and which extends in movement direction of the handle piece 150 along the extension of the handle portion 151 on the right-hand side. A spring stop 154 is located at the left-hand end of the recess 155. Therefore, the recess 155 forms a receptacle for a compression spring 102.

FIG. 4b shows the locking bolt 160 and the handle piece 150 also in an exploded view and from a rear side referring to FIG. 4a.

As can be seen, the locking bolt 160 also has a recess 170 which is preferably semicircular in cross section and which extends parallel to recess 155 in the assembled condition and, together with the latter, forms a receiving channel with a circular cross section. At the end of the recess 170 facing the stop surface 156 of the handle piece 150, a spring stop 169 is located at the locking bolt 160.

In other words, the spring 102 is received in the channel 155, 170 and suspended between the spring stops 154, 169. As a result, the spring 102 acts as a compression spring and therefore urges the handle piece 150 in direction of a stop surface 171 of the locking bolt 160 and, therefore, into the housing 110.

This means that the handle piece 150 is urged in the direction of locking in the respective position so that the locking bolt 160 is also securely held in the corresponding position.

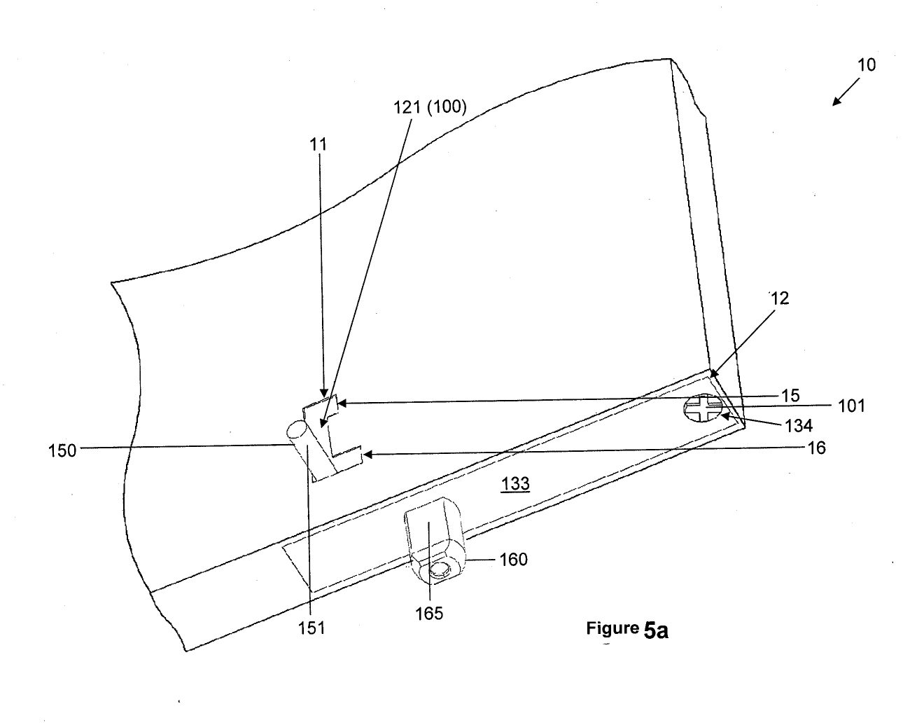

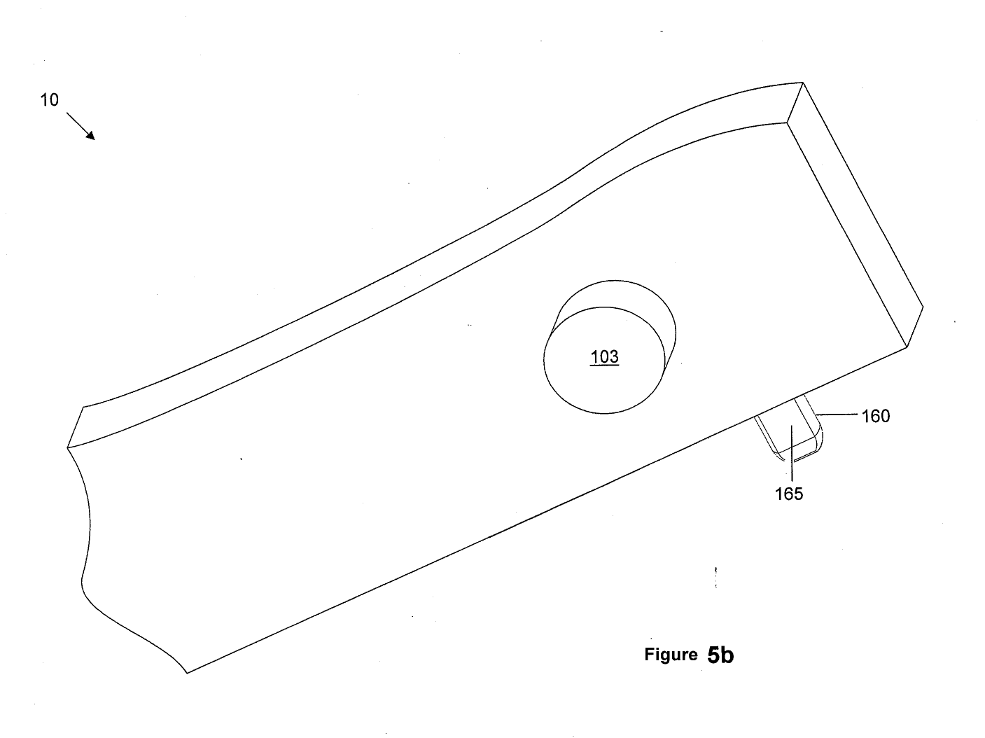

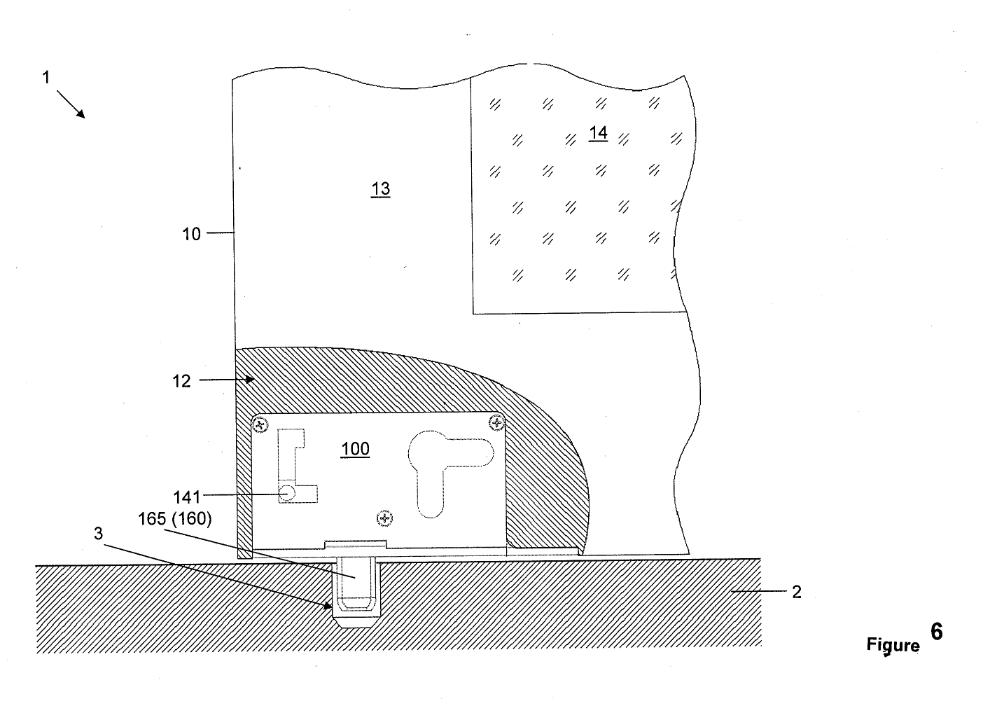

FIG. 5a shows a leaf 10 which is outfitted with a locking device 100 of this kind.

For example, the handle piece 150 has only one handle portion 151. To receive the handle portion 151, the leaf 10 has an aperture 11 which corresponds to the aperture 121 of the locking device 100 and through which the handle portion 151 passes. In other words, the aperture 11 also comprises locking recesses 15, 16. Accordingly, the handle portion 151 can also be operated or actuated from the outside with respect to the leaf 10.

The locking device 100 is fastened to the leaf 10 by the above-mentioned screws 101 and the fastening hole 134 in the face plate 133 at the leaf 10. The leaf 10 has a corresponding receiving opening 12 for receiving the locking device 100. The locking projection 165 of the locking bolt 160 is shown emerging from the lower edge of the leaf 10 by way of example.

FIG. 5b shows the leaf 10 from a substantially opposite perspective with respect to FIG. 5b.

The locking projection 165 of the locking bolt 160 and a turning knob 103 are the only components of the locking device 100 seen in the drawing. As was described above, the turning knob 103 is provided with a lock bit and is operatively connected therewith so as to be fixed with respect to rotation relative to it. In other words, turning the turning knob 103 causes the locking projection 165 to move into or out of the leaf 10.

The turning knob 103 is preferably a security turning knob; that is, it only connects with the lock bit when a person identifies himself in a known manner, for example, by an RFID pass.

In other words, the locking device 100 can easily be used in leaves that must be secured against unauthorized opening from one side of the respective leaf such as in entrance doors of businesses, for example.

FIG. 6 shows a leaf installation 1 which is provided with the leaf 10 from FIG. 5.

The leaf 10 is formed, for example, as a frame door leaf, i.e., it has a glass panel 14 enclosed by and held in a surrounding frame profile 13.

For example, a locking device 100 is arranged in the region of a closing edge of the leaf 10 in the lower, horizontally extending part of the frame profile 13. The leaf 10 is shown in section in this region. The locking device 100 is arranged and received in the above-mentioned recess 12 of the leaf 10.

The locking device 100 is shown in the locking position in which the leaf 10 is prevented from moving. In this position, the locking projection 165 engages in a locking receptacle 3 formed in the floor 2. The locking receptacle 3 can be formed, for example, by a floor bushing recessed into the floor 2.

The invention is not limited to the embodiment form described above.

The locking device 100 can have a housing of any shape. The form of a door lock case has the advantage that there already exist standard dimensions for it which make it easy to install the locking device 100.

An aperture 121, 131, 141 and 141, 132, 122, respectively, need only be formed on one side instead of in both housing parts 120, 130.

The aperture 11; 121; 131 can be provided without locking recesses 15, 16; 124, 125; 139, 150, or with only one locking recess.

Locking solutions other than locking recesses 15, 16; 124, 125; 139, 150 can also be used. For example, the locking bolt 100 could have a spring-loaded detent ball on one side facing an inner side of the housing 110, which detent ball engages in the respective end position in a corresponding detent recess in the very same inner side of the housing 110.

The aperture 11, 121, 131 need not be angular. In particular, the transition to the respective locking recess 15, 16; 124, 125; 139, 150 can be formed by a bevel and/or respectively rounded corners. This also allows the locking projection 165 to be moved from one end position into the other by rotating the transmission part 180 even when the handle piece 151 has engaged in a respective locking recess 15, 16; 124, 125; 139, 150.

The locking projection 165 can also engage in a corresponding receptacle of a leaf frame in the locking position instead of in a recess in the floor 2. This is an option, for example, in swinging doors in rest rooms which are locked and unlocked from the inside conventionally by a handle piece or the like, i.e., without auxiliary elements. However, in case of an emergency in which a person needs help but is not able to exit the toilet unassisted, an authorized person can gain access to the toilet from the outside, for example, by the above-mentioned RFID pass, to assist the person.

Alternatively, the locking projection 165 can also engage in a corresponding receptacle of an opposite leaf 10 in the locking position; that is, door installations having more than one leaf can also be locked easily.

The housing 110 can be assembled in any other manner instead of by screwing, for example, by snapping, clamping or gluing together or the like. This also applies to installation in the leaf 10. The face plate 133 is also not required if another type of fastening of the housing 110 is provided.

Alternatively, the housing 110 can also be fitted to the leaf 10.

The locking bolt 160 can also have two projections 164 instead of one. This would allow a security closure. In this case, the movement path of the handle piece 150 would have to be adapted.

The handle piece need have only one handle portion 151. However, a plurality of handle portions can also be provided.

The lock cylinder can be replaced by a lock cam so that a door knob can be installed.

The locking bolt 160 can be designed such that its locking portion 165 has the form of a door latch. The locking bolt is then advantageously preloaded in direction of the locking position. This allows the locking device to be used as a replacement for leaf locks which do not have deadbolts. This is the case, for example, with doors inside a building. The advantage consists in that these doors can also be adapted subsequently to function such that the room behind the door can only be entered by authorized persons. In view of the fact that the housing 110 can also be adapted to the shape of a lock of this kind, no further changes need be made to the door installation apart from exchanging the door lock for a locking device according to the invention.

The locking device 100 can be applied to any type of leaf 10 or leaf installation 1 that has a leaf 10 which is locked and which is therefore necessarily movable. Therefore, suitable leaves are window sashes, door leaves, modular partitions, and so on.

In conclusion, the invention provides a space-saving, simply constructed, inexpensive, versatile and easily assembled leaf lock which allows a respective leaf to be locked and unlocked from one side without auxiliary and from the other side with auxiliary such as keys, RFID passes, etc. In other words, the leaf can be used, for example, for escape paths without compromising security in the direction opposite to the escape direction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. A locking device comprising:
a housing configured to be installed one of in a stationary manner in a leaf and arranged at the leaf in a stationary manner;
a locking element that is movable translationally into and out of the housing such that the locking element projects out of the housing in a locking position;
at least a first actuating device that comprises a handle piece that is accessible from the outside with respect to the housing, the first actuating device is operatively connected to the locking element such that the locking element is moved into and out of the housing when the handle piece is moved along a predetermined movement path; and
a second actuating device received in the housing comprising a transmission device configured to be rotationally actuated and turned by a turning part that is accessible from outside the housing and which is operatively connected to the locking element so that the locking element is moved out of the housing when the turning part in turned in a locking direction.

2. The locking device according to claim 1, wherein one of the turning part and the handle piece is moved along with a movement of the handle piece or turning part, respectively.

3. The locking device according to claim 1, wherein the lock is configured to lock the locking element at least in locking position.

4. The locking device according to claim 3, wherein the housing is configured to correspond to the respective position to be locked to prevent one of the handle piece and the turning part from moving away from its locked position to at least a predetermined extent.

5. The locking device according to claim 3, further comprising an element configured to urge the locking element in or away from the direction of the locking position.

6. The locking device according to claim 3, wherein at least one of the first actuating device and the second actuating device is operatively connected to the locking element such that the locking element is moved into the housing when moving one of the handle piece or turning the turning part in a direction corresponding to a movement direction of the locking element away from the locking position.

7. The locking device according to claim 1, wherein the turning part has at an outer circumference thereof a lock bit that is rotated along with a rotation of the turning part and which drives the locking element in a predetermined portion of a turning movement so that the locking element is moved translationally.

8. The locking device according to claim 1, wherein the turning part has a profile cylinder which is accessible from one or both sides and which is inserted in a stationary manner into the housing and is configured to be turned at least in locking direction by a key.

9. The locking device according to claim 1, wherein the transmission device comprises one of a turning knob and a door handle arranged to be one of fixed with respect to rotation relative to the turning part and coupled with the turning part so as to be fixed with respect to rotation relative to it, at least in locking direction.

10. A leaf which has at least one locking device comprising:
a housing configured to be one of installed in a stationary manner in a leaf and arranged at the leaf in a stationary manner;
a locking element that is movable translationally into and out of the housing such that the locking element projects out of the housing in a locking position;
at least a first actuating device that comprises a handle piece that is accessible from the outside with respect to the housing, the first actuating device is operatively connected to the locking element such that the locking element is moved into and out of the housing when the handle piece is moved along a predetermined movement path; and
a second actuating device received in the housing comprising a transmission device configured to be rotationally actuated and turned by a turning part that is accessible from outside the housing and which is operatively connected to the locking element so that the locking element is moved out of the housing when the turning part in turned in a locking direction,
wherein the leaf is configured to receive or hold the locking device in a stationary manner such that the locking element protrudes from the leaf when the locking element projects out of the housing.

11. The leaf installation having at least one leaf according to claim 10, wherein the leaf is movable with respect to the leaf installation, and having a locking receptacle, wherein the locking receptacle and the locking element are arranged such that the locking element engages in the locking receptacle in the locking position such that the leaf is prevented from moving in at least one movement direction.
